(19) United States
(12) Patent Application Publication
(10) Pub. No.: US 2015/0256364 A1
(43) Pub. Date: Sep. 10, 2015

(54) GROUP DELAY BASED BACK CHANNEL POST CURSOR ADAPTATION

(71) Applicant: LSI Corporation, San Jose, CA (US)

(72) Inventors: Mohammad S. Mobin, Orefield, PA (US); Vladimir Sindalovsky, Perkasie, PA (US)

(73) Assignee: LSI Corporation, San Jose, CA (US)

(21) Appl. No.: 14/248,624

(22) Filed: Apr. 9, 2014

Related U.S. Application Data
(60) Provisional application No. 61/950,355, filed on Mar. 10, 2014.

(51) Int. Cl. H04L 25/03

(52) U.S. Cl. CPC H04L 25/03057

(57) ABSTRACT

Described embodiments provide for de-coupling between adaptation of decision feedback equalizer (DFE) filter taps and transmitter (TX) post cursor filtering in group delay (GD)-based adaptation. Consequently, an excessive build-up of transmitter post cursor effects and its excessive equalization cancellation by the DFE may be substantially reduced or eliminated. By breaking this coupling, a transmitter does not over equalize a signal, the DFE does not attempt to “undo” the over equalization, and a variable gain amplifier (VGA) in the receiver front end data path generally does not apply gain to amplify the signal back again due to the reduced DC level. GD-based TX post cursor adaptation may reduce over equalization effect and hence save power and increase performance by not over equalizing the signal.

### CROSS-REFERENCE TO RELATED APPLICATIONS

This application claims the benefit of the filing date of U.S. provisional application No. 61/950,355, filed on Mar. 10, 2014 as attorney docket no. L13-1410PROV, the teachings of which are incorporated herein by reference.

The subject matter of this application is related to U.S. patent application Ser. No. 13/552,012, filed Ser. No. 07/182,012, now published as US2014/0023131; and is related to U.S. patent application Ser. No. 13/315,831, filed Dec. 9, 2011, now published as US2013/0148712; and is related to U.S. patent application Ser. No. 12/323,155, filed Nov. 25, 2008, now published as US2010/0128828, the teachings of all of which are incorporated herein in their entirety by reference.

### BACKGROUND

Typically, a digital communications system utilizes a transmitter (TX) located at the transmitting location to transmit a digital communication signal across a physical communication medium, also known as a communications channel, to a receiver (RX) located at the receiving location. The receiver must sample an analog waveform and then reliably detect the sampled data. A serializer/deserializer (SerDes) is commonly used in devices for high speed communications to convert data between serial and parallel interfaces in each transmit/receive direction. As in most types of communication receivers, SerDes devices employ gain adjustment of received signals prior to equalization (e.g., in a linear equalizer (LEQ) and subsequent processing (e.g., Multiplexers (MUX) and decision feedback qualization (DFE)). Amplification is usually accomplished using a variable gain amplifier (VGA).

An eye pattern, also known as an eye diagram (the “eye), represents a digital data signal from a receiver that is repetitively sampled and applied to the vertical input (axis), while the horizontal input (axis) represents time as a function of the data rate. The eye diagram allows for evaluation of the combined effects of channel noise and inter-symbol interference on the performance of a baseband pulse-transmission system, and the eye is the synchronized superposition of all possible realizations of the signal of interest viewed within a particular signaling interval.

Signals arriving at a receiver are typically corrupted by inter-symbol interference (ISI), crosstalk, echo and other noise. Generally, ISI is caused by variations in group delay (GD) and loss through the communication media, which is a function of the transmitted data pattern. This causes the data eye to be closed in the horizontal direction (timing wise) and vertical direction (amplitude attenuation of the serial data at the clock and data recovery (CDR) input). In order to compensate for such channel distortions, the receivers often employ well-known filtering, amplification and equalization techniques. For example, linear equalization (LEQ) or decision-feedback equalization (DFE) techniques (or both) are often employed for removing ISI and other correlated noises. Such equalization techniques are widely-used for removing ISI and to improve the noise margin. See, for example, R. Gitlin et al., Digital Communication Principles, (Plenum Press, 1992) and E. A. Lee and D. G. Messerschmitt, Digital Communications, (Kluwer Academic Press, 1988), each incorporated by reference herein. High speed modems use adaptive equalizers to compensate for non-constant group delay.

Methods and devices exist for reliable back channel post cursor adaptation. In this case, a transmitter finite impulse response filter (TX FIR) filter is employed in the transmitter to pre-condition the transmitted signal, which pre-conditioning includes both pre-cursor and post-cursor components. Known methods use least mean square (LMS)-based, back channel, post cursor adaptation to adaptively generate filter coefficients for the TX FIR post cursor. This LMS-based method uses the error between a data value and an error slicer value in order to calculate, filter and decide on post cursor increment or decrement request through back channel communication. The LMS-based algorithm for post cursor back channel adaptation often has dependence from the DFE (filter) tap coefficient “1” and may run away or settle to undesirable value. In classical LMS-based adaptation, both DFE and TX FIR post cursor operation equalizes channel post cursor degradation. If the TX FIR post cursor over equalizes, then the DFE undoes this over-equalization. However, this process, or coupling of the operations of the TX FIR post cursor and the DFE, has a power penalty, since a variable gain amplifier (VGA) in the receiver data path must amplify the received signal prior to input to the DFE. Furthermore, as the VGA amplifies an over equalized signal, a band width of a data path may decrease, taking away boost margin offered by a linear equalizer (LEQ) that follows the VGA, which in turn limits a channel insertion loss support capability of the SerDes.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Described embodiments provide for group delay-based post cursor adaptation in a communication system. At a local receiver, a serial signal is received from a communication channel from a remote transmitter, wherein at least a portion of interference introduced into the serial signal passing through the communication channel is compensated for by applying a transmit (TX) filter in the remote transmitter to the serial signal, and wherein the TX filter includes at least one pre- and post-cursor tap with corresponding pre- and post-cursor tap coefficients, respectively. The local receiver enhances and applies equalization to the received serial signal; and determines either: a hold, an increment request, or a decrement request for the post cursor tap coefficient of the TX filter to compensate for channel distortions. Each increment request and each decrement request is forwarded to a remote receiver by a local transmitter through a back communication channel. The local receiver detects either over equalization or under equalization at the local receiver, and if over equalization is detected, generates a request for a reduction of absolute value for the post cursor tap coefficient of the TX filter, and otherwise, if under equalization is detected, generates a request for an increase of absolute value for the post cursor tap coefficient of the TX filter.

### DESCRIPTION OF THE DRAWING FIGURES

Other aspects, features, and advantages of the present invention will become more fully apparent from the following detailed description, the appended claims, and the accompanying drawings in which like reference numerals identify similar or identical elements.

FIG. 1 shows a simplified block diagram of a Serializers/Deserializers (SerDes) receiver with group delay based post cursor back channel adaptation in accordance with exemplary embodiments;

FIG. 2 shows an eye diagram of a receiver serial data at the slicers circuit of the SerDes receiver shown in FIG. 1;

FIG. 3 shows a state of over equalization of a TX FIR signal exhibiting the group delay based post cursor back channel adaptation in a transition spread in accordance with embodiments;

FIGS. 4A-4C show cases of under equalization, equalization, and over equalization of a TX FIR signal, respectively, in accordance with embodiments;

FIG. 5 shows an exemplary method of group delay based post cursor back channel adaptation in accordance with embodiments; and

FIG. 6 shows an exemplary method for a step shown in FIG. 5.

### DETAILED DESCRIPTION

Hereinafter, embodiments are described with reference to the drawings. Described embodiments relate to a method and apparatus for group delay (GD)-based post cursor back channel adaptation.

Contemporary Serializer/Deserializer (SerDes) devices operate at high serial data rates and over long connection media, causing serial input signal degradation through attenuation and inter-symbol interference (ISI). In order to recover serial signal error free (or with very low error rate), clock and data recovery devices (CDR) may use analog and digital techniques for correction incorporating adaptable parameters.

In GD-based adaptation in accordance with described embodiments, a coupling that occurs between adaptation of decision feedback equalizer (DFE) filter taps and transmitter (TX) post cursor filtering may be broken (“de-coupled”); consequently, an excessive build-up of transmitter post cursor effects and its excessive equalization cancellation by the DFE may be substantially reduced or eliminated. By breaking this coupling, a transmitter does not over equalize a signal, the DFE does not attempt to “undo” the over equalization, and a variable gain amplifier (VGA) in the receiver front end data path generally does not apply gain to amplify the signal back again due to the reduced DC level. By de-coupling, GD-based TX post cursor adaptation may positively reduce operating power and increase performance in, for example, a SerDes system. GD-based TX post cursor adaptation may reduce over equalization effect and hence save power and increase performance by not over equalizing the signal.

Note that herein, the terms “signal” and “data” may be used interchangeably. It is understood that a signal may correspond to, or relate to a set of data, and that the set of data may refer to the signal.

The following detailed description utilizes a number of acronyms, which are generally well known in the art. While definitions are typically provided with the first instance of each acronym, for convenience, Table 1 provides a list of the acronyms and abbreviations used along with their respective definitions.

TABLE 1

| | | | |
|---|---|---|---|
| SerDes | serializer/deserializer | RXFE | RX front end |
| CDR | clock and data recovery | AEQ | analog equalizer |
| GD | group delay | FIR | finite impulse response |
| DFE | decision feedback equalizer | ISI | inter symbol interference |
| TX | transmitter | VGA | variable gain amplifier |
| RX | receiver | LEQ | linear equalizer |
| BER | bit error rates | CMI | pre cursor coefficients |
| LSM | least mean square | CPI | post cursor coefficients |
| RXEQ | RX equalization | | |

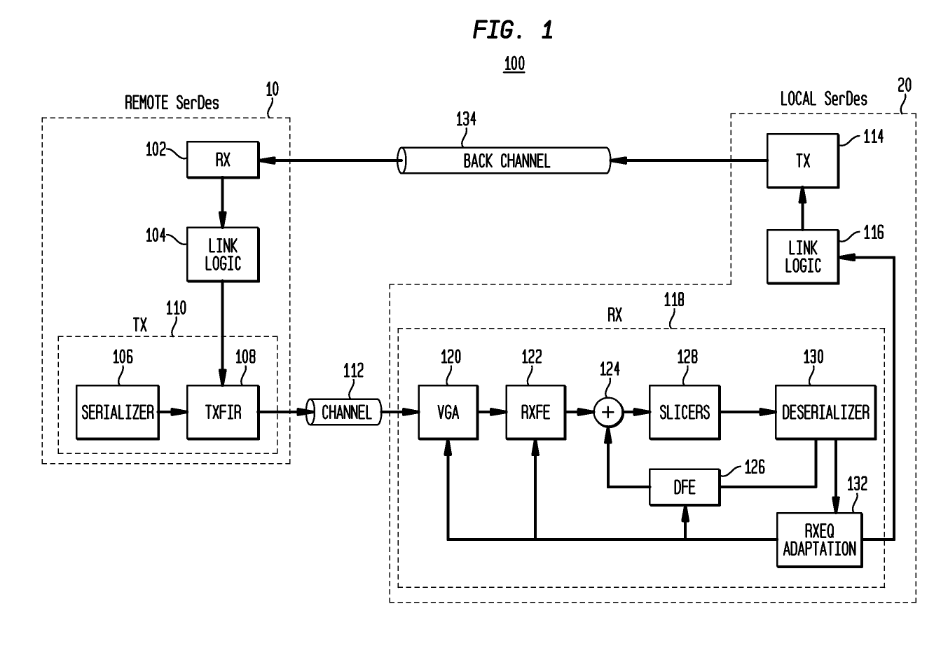

FIG. 1 shows a simplified block diagram of a SerDes receiver for GD-based post cursor back channel adaptation in accordance with exemplary embodiments.

As shown, SerDes system 100 includes remote SerDes 10 and local SerDes 20. Remote SerDes 10 includes receiver (RX) 102, link logic 104, and a remote transmitter (TX) 110 having a serializer 106 and TX finite impulse response (TX FIR) filter 108. Local SerDes 20 includes transmitter 114, link logic 116, and receiver 118. Receiver 118 includes variable gain amplifier (VGA) 120, receiver front end circuitry (RXFE) 122, combiner 124, slicers 128, deserializers 130, decision feedback equalizer (DFE) 126 and receiver equalization (RXEQ) adaption circuitry 132. Channel 112 and back channel 134, which may be wired, wireless, optical or some other connection media, have an associated transfer function, loss characteristics, and/or other means for adding impairments to signals passing through it, respectively. Here, VGA 120, RXFE 122, combiner 124, slicers 128, deserializer 130, DFE 126, and RXEQ adaption 132 may be selected from any existing and prospective RXFEs, adders, slicers, deserializers, DFEs and RXEQ adaption circuits known in the art. The technology of VGA 120, RXFE 122, combiner 124, slicers 128, deserializer 130, DFE 126, and RXEQ adaption 132 is also well known to one skilled in the art.

While not shown explicitly, link logic 116, REXEQ adaptation 132 and other control logic and circuitry associated with the various elements forms a “controller” for local SerDes 20. As would be apparent to one skilled in the art, such control might be centralized through a processor with corresponding software and hardware, or distributed in dedicated logic circuitry, or a combination of both. As such, the controller functionality might include various forms of sensing and data gathering within local SerDes 20 to perform operations described herein.

A serial signal out of serializer 106 may be transmitted from remote transmitter TX 110 of remote SerDes 10 through channel 112 to receiver RX 118 of local SerDes 20. In order to pre-condition the serial signal on the remote transmitter TX 110 side, multi-tap FIR (i.e., TX FIR 108) filter may be applied to the serial signal (and, thus, applying pre- and post-cursor coefficients). In one exemplary embodiment, TX FIR filter 108 may typically be a 3-tap FIR. After passing through channel 112, the signal is attenuated and distorted due to frequency dependent group delay (GD) variation.

On entering receiver RX 118, receiver RX 118 receives the incoming serial signal from channel 112, and performs signal enhancements before sampling the incoming serial signal in slicers 128 in order to perform adaptation function. Such enhancement includes amplifying the incoming serial data from channel 112 in VGA 120, and filtering the signal frequency range in RXFE 122 to compensate for frequency dependent degradation of the serial data from channel 112 in channel media. VGA 120 and RXFE 122 are generally implemented by analog circuitry.

RXFE 122 has variable filtering parameters and adjusts to compensate (to the best of its ability depending on implementation) frequency dependent distortions in channel 112. The effect of RXFE 122 may usually be a form of high pass filtering. Since RXFE 122 does not necessarily compensate to a full extent frequency dependent distortions of channel 112, additional DFE processing may be applied to the analog serial signal. DFE 126 may be applied to restore the incoming signal and compensate additional degradation of the signal (such as reflections).

A decision feedback equalizer (DFE) is a filter that uses feedback of detected and/or decisions for detected symbols in addition to conventional equalization of currently received (and sometimes future—for TX equalization) symbols. Some systems use predefined training sequences to provide reference points for the adaptation process of a DFE filter taps technique to generate tap values applied to detected symbols, to estimate time-shifted pulse energy distortion contributions to a current, received symbol.

According to DFE techniques, feedback compensation is applied to the incoming serial data based on the previously received serial data in order to compensate for the ISI. DFE 126 may be implemented in continuous time domain, but more often DFE 126 is implemented in discrete time domain.

As described with respect to FIG. 1, DFE 126 stores previously received serial data, applies corresponding DFE tap weights to the serial data, and applies the processed serial data to combiner 124 (between RXFE 122 and slicers 128). Previously received serial data yₖ is multiplied by corresponding coefficients according to relation (1).

$${y}_{i} = {x}_{i} - {\sum }_{k = 1}^{k = n} {c}_{k} * {w}_{k} * {y}_{i - k} \qquad ( 1 )$$

where n is a depth of DFE correction (related to a number of filter taps), cₖ is an adapted DFE coefficient value, wₖ is weight of a binary bit (e.g., in mV/bit), xᵢ is incoming receiver (RX) serial data, yᵢ is a current bit of serial data at the slicers input, and yᵢ₋ₖ is previously received data that the DFE has corrected.

The depth of the DFE correction n can vary, and typically is set during a particular implementation as a trade-off between complexity (e.g., number of DFE filter taps and operations) and the energy spread of the ISI. In one exemplary embodiment, DFE 126 is implemented as a 6 tap DFE. Depending on the value of the stored latest 6 bits of received data, ±1 bit multiplied with the signal tap is subtracted from the output of RXFE 122. The magnitude of added or subtracted value is defined by the digital value of the corresponding DFE tap cᵢ and its weight wᵢ.

Each DFE coefficient value cₖ is typically adapted using an adaptation process (or algorithm) implemented via RXEQ adaptation 132. Such adaptation process and algorithms employ the decisions for the detected deserialized data and monitored error, and such adaptation process and algorithms are well known to one skilled in the art.

After all enhancements to the serial signal with VGA 120, RXFE 122 and DFE 126, the serial signal is “sliced” in slicers 128 to sample the serial signal to a digital discrete timing domain.

Since many of parameters in transmitter TX 110 and receiver RX 118 are variable, it is desirable to set them to relatively optimum values, and a preferred method in a constantly changing and initially unpredictable environment is via real time adaptation. A typical adaptation algorithm is Least Mean Square (LMS) algorithm which uses data and error samples for adaptation.

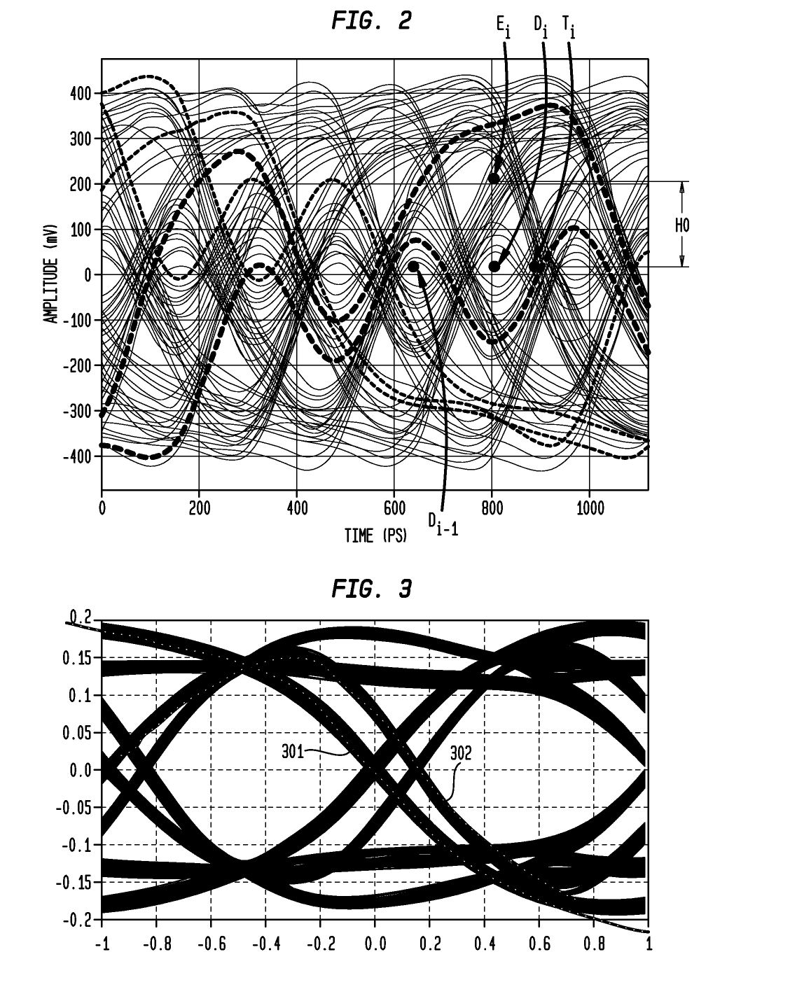

FIG. 2 shows an eye diagram of the received serial data at the slicers circuit (e.g., slicers 128) of the SerDes receiver shown in FIG. 1.

As shown in FIG. 2, transition samples Ti are aligned by clock and data recovery (CDR) to the statistical middle of all data eye traces crossing zero level for the nth sample. This places data samples Di (generating D(n)) approximately in the middle of the eye opening. Error slicer Ei has the same timing as the data slicer but is vertically offset by ±H0 (related to the first DFE tap value) to produce e(n). An implementation might include one error slicer or two error slicers per each eye. The value of vertical offset is adapted through LMS algorithm placing error latch in the statistical middle of all data eye traces at a sampling time instant. LMS algorithm for H0 adaptation may be described as follows by relation (2):

H0(n+1)=H0(n)+μe(n)D(n) (2)

where m is an adaptation factor to control adaptation speed.

VGA gain is typically adapted along with, and based upon, H0 adaptation to get desired vertical data eye opening. After the H0 value is adapted, the adaptation of the DFE coefficients cₖ starts. The adaptation of the DFE coefficients cₖ may be described by the LMS algorithm by relation (3) where the offset between indexes of the error and data latches corresponds to the DFE coefficient index. Thus, DFE coefficients hₘ, m=1, 2, . . . , M, are adapted in a similar way as described by relation (3):

Hₘ(n+1)=Hₘ(n)+μe(n)D(n−m) (3)

Adapted DFE coefficients Cₙ provide for the optimized vertical opening of receiver eye compensating to the ISI.

Then, LMS based analog equalizer (AEQ) is adapted with multi tap averaging shown by relation (4) for the case of 4 taps. Dₜₕ in this relation is an average of Dᵢ₋₄ through Dᵢ₋₁ and E is the ith error value.

$$aeq = ( \overline{{D}_{i} ⋀ {Esign}_{i}} ) ? {\sum }_{⋂}^{∞} ( \overline{{D}_{ih} ⋀ {E}_{i}} ) \qquad ( 4 )$$

When initially all of the RX parameters are adapted to the incoming serial signal, the back channel adaptation of remoter TX FIR filter 108 is usually performed in order to further enhance the quality of the incoming serial signal.

TX FIR filter coefficients to be adapted are typically pre- and post-cursor coefficients CM1 and CP1. The receiver algorithm defines a desired increment and decrement for the corresponding TX FIR filter coefficients, and the corresponding requests are sent by local transmitter 114 through back channel 134 to remote receiver 102. Link logic 104 of remote SerDes 10 then interprets the requests and sends acknowledgement to local receiver RX 108. Since back channel 134 is not necessarily adapted by this time to high data rate transmissions, back channel 134 requests are sent at much lower rate with protocol exchange.

While pre cursor coefficients CM1 adaptation is not directly correlated with VGA, AEQ, or DFE adaptation, post cursor coefficients CP1 adaptation is strongly intertwined with adapted DFE coefficient C₁. In certain cases due to signal compression and adaptation loop interaction CP1 builds up to higher than optimal value causing over equalization which results in poor horizontal eye opening. To ensure that remote TX FIR post cursor coefficients CP1 does not get over equalized, a group delay (GD-) based CP1 adaptation scheme is employed in the described embodiments.

The GD-based adaptation recognizes that, if a data eye is over equalized due to above mentioned anomalies, the state of the over equalization exhibits itself in a transition spread, such as the transition spread as shown in FIG. 3. In FIG. 3 each of the paths 301 and 302 represent data transitions for over equalization, where a spread of nearly 0.2 UI (unit interval) occurs. When the signal is over equalized, an input data signal 1T pattern will transition after a long run length of the patterns. In this case, CP1 magnitude may be reduced. On the other hand, when the 1T pattern transitions before the long run patterns, the CP1 magnitude may be increased.

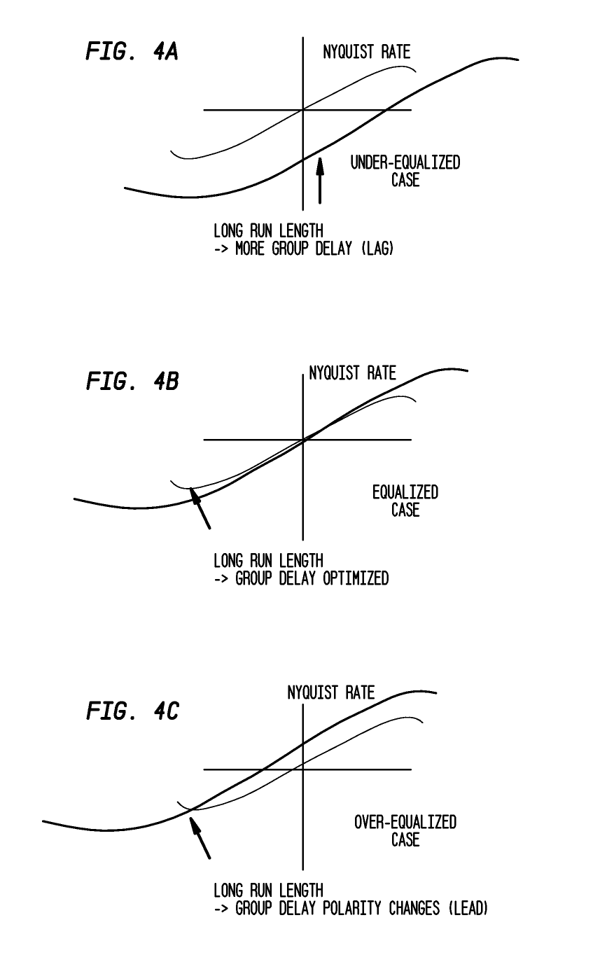

Described cases of under equalization, equalization, and over equalization of CP1 are shown in FIG. 4A-FIG. 4C. FIG. 4A-FIG. 4C show cases of under equalization, equalization, and over equalization of a TX FIR signal, respectively.

An exemplary adaptation truth table for group delay gradients is presented in Table 2.

TABLE 2

| v(n − 2) | v(n − 1) | v(n − ½) | v(n) | te(n) |
|---|---|---|---|---|
| −1 | −1 | −1 | 1 | −1 \|CP1\| |
| −1 | −1 | 1 | 1 | 1 \|CP1\| |
| 1 | 1 | −1 | −1 | 1 \|CP1\| |
| 1 | 1 | 1 | −1 | −1 \|CP1\| |

where v(n) is sliced DFE data decision, v(n−1/2) represents a sliced transition sample, v(n−1), v(n−2) are 1T and 2T previous DFE data decisions, and te(n) corresponds to reverse TX FIR coefficient CP1 magnitude step up or step down (UP/DN) request, where the normalized step increment is “1”. Note, over-equalization is detected by evaluating x110 and x001 sequences.

All other combinations of v(n−2), v(n−1), v(n−1/2), v(n) result in te(n)=0, where the te(n) value represents adaptation error and 0 represents no error, and so no CP1 step up or step down in coefficient value is required.

In Table 2, TX FIR coefficient CP1 UP/DN request (i.e., the te(n) value) is defined by a comparison of 1T transition timing vs. long run transition timing. When the 1T transition appears after a long run transition, an over equalized scenario is detected, as shown in FIG. 4C. In this event the GD based CP1_UP request is generated to increment the CP1 coefficient value. On the other hand, when the 1T transition happens before the long run length transition, an under equalized scenario is detected, as shown in FIG. 4A. In this case the GD based CP1_DN request is generated to decrement the CP1 coefficient value.

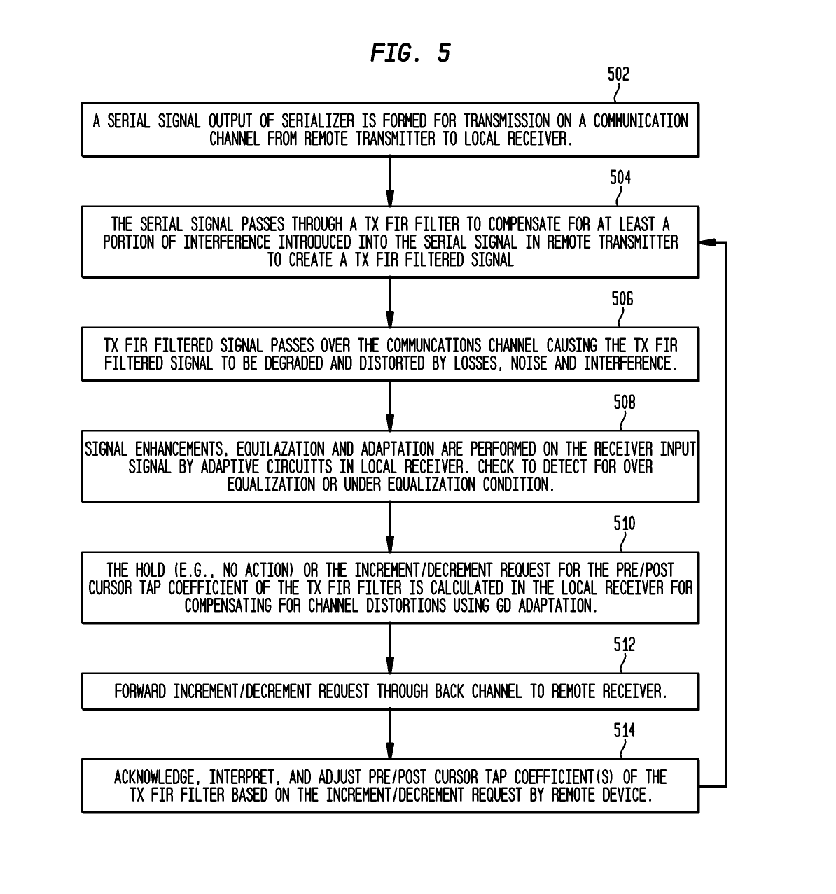

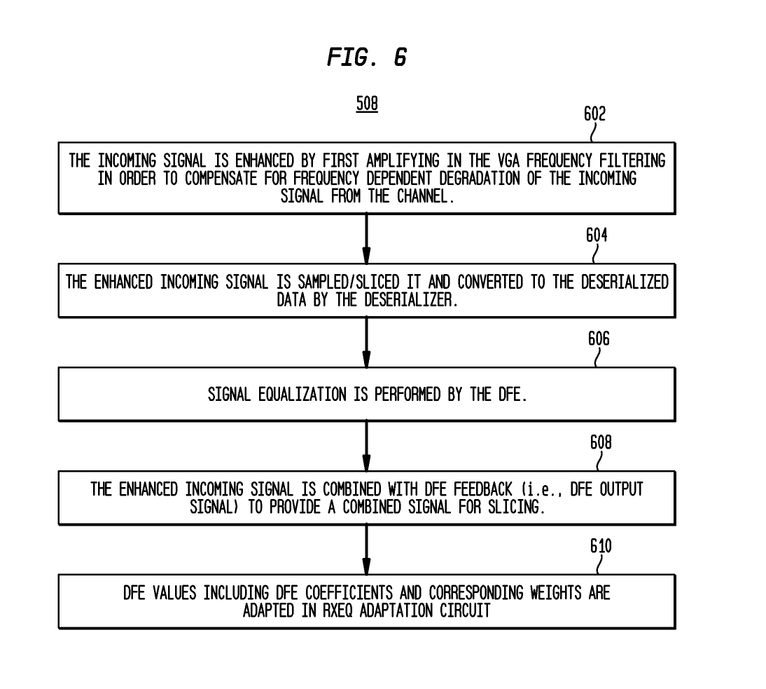

FIG. 5 shows an exemplary method 500 of GD-based post cursor back channel adaptation in accordance with embodiments.

As shown, at step 502, a serial signal output of serializer 106 is formed for transmission on a communication channel from remote transmitter 110 to local receiver 118. At step 504, the serial signal passes through TX FIR filter 108 to compensate for at least a portion of interference introduced into the serial signal in remote transmitter 110 to create a TX FIR filtered signal. The TX FIR filter 108 includes at least one pre/post cursor tap that has a pre/post cursor tap coefficient (CP0/CP1), respectively. At step 506, the TX FIR filtered signal passes over the communications channel causing the TX FIR filtered signal to be degraded and distorted by losses, noise and interference, such as, ISI, to create a received signal passed to local receiver 118 as a receiver input signal. At step 508, signal enhancements, equalization and adaptation are performed on the receiver input signal by adaptive circuitry (e.g., front end amplifiers, filters, equalizer(s), etc.) in local receiver 118. A check to detect for over or under equalization is performed at the local receiver. At step 510, the hold (e.g., no action) or the increment/decrement request for the pre/post cursor tap coefficient(s) of the TX FIR filter is calculated for compensating for channel distortions based on GD adaptation. When over equalization is detected, an increment request is generated for CP1 of the TX FIR filter, otherwise, when under equalization is detected, a decrement request is generated for CP1 of the TX FIR filter. At step 512, local transmitter 114 forwards the increment/decrement request for the pre/post cursor tap coefficient(s) of the TX FIR filter through back communication channel 134 to remote receiver 102. At step 514, remote SerDes link logic 104 acknowledges, interprets, and adjusts pre/post cursor tap coefficient(s) of the TX FIR filter based on the increment/decrement request.

FIG. 6 shows an exemplary method for step 508 shown in FIG. 5. As shown, once the receiver input signal from channel 112 is received by local receiver 118, the incoming signal is enhanced at step 602. The incoming signal is first amplified in VGA 120, and then, its frequency is filtered by RXFE 122 in order to compensate for frequency dependent degradation of the incoming signal from channel 112 in channel media. At step 604, the enhanced incoming signal is sampled/sliced in slicers circuit 128 and converted to the deserialized data by deserializer 130. At step 606, signal equalization is performed by DFE 126 (which may be implemented in a discreet time domain). DFE 126 stores previously received serial data, multiplies by corresponding coefficients (e.g., according to relation (3)), and applies the DFE filtered previously received serial data to combiner 124 between RXFE 122 and slicers circuit 128. At step 608, the enhanced incoming signal is combined at combiner 124 with DFE feedback (i.e., DFE output signal) to provide a combined signal for slicers circuit 128. At step 610, DFE values including DFE coefficients and corresponding weights are adapted in RXEQ adaptation circuit 132.

The following describes simulation results for a SerDes system employing exemplary embodiments. As illustrated in the following simulations, gradient interaction of TX FIR, LEQ, and DFE is shown and GD based techniques bring balance into the adaptation process.

In summary, in a system (such as a SerDes system) including GD-based adaptation operating in accordance with exemplary embodiments, the coupling between the DFE taps and TX post cursor is broken. Thus, excessive buildup of TX post cursor and its excessive equalization cancellation by DFE tap is broken. As a result of breaking this coupling, the transmitter does not over equalize the signal, the DFE does not undo the over equalization, and the VGA does not amplify the signal back again, and all these effects positively reduces SerDes operating power and performance. GD based TX FIR CP1 adaptation prevents over equalization in back channel adaptation, and thus facilitates better horizontal eye opening and results in better jitter tolerance and lower Bit Error Rates (BER).

Reference herein to “one embodiment” or “an embodiment” means that a particular feature, structure, or characteristic described in connection with the embodiment can be included in at least one embodiment. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, or apparatus.

While the exemplary embodiments have been described with respect to processes of circuits, including possible implementation as a single integrated circuit, a multi-chip module, a single card, or a multi-card circuit pack, the embodiments are not so limited. As would be apparent to one skilled in the art, various functions of circuit elements may also be implemented as processing blocks in a software program. Such software may be employed in, for example, a digital signal processor, micro-controller, or general purpose computer.

The use of figure numbers or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

No claim element herein is to be construed under the provisions of 35 U.S.C. §112, sixth paragraph, unless the element is expressly recited using the phrase “means for” or “step for.”

It will be further understood that various changes in the details, materials, and arrangements of the parts which have been described and illustrated in order to explain the nature of described embodiments may be made by those skilled in the art without departing from the scope as expressed in the following claims.

We claim:

1. A method of group delay-based post cursor adaptation in a communication system, the method comprising the steps of:
receiving, at a local receiver, a serial signal from a communication channel from a remote transmitter, wherein at least a portion of interference introduced into the serial signal passing through the communication channel is compensated for by applying a transmit (TX) filter in the remote transmitter to the serial signal, wherein the TX filter includes at least one pre- and post-cursor tap with corresponding pre- and post-cursor tap coefficients, respectively;
enhancing and applying equalization to the received serial signal;
determining either a hold, an increment request, or a decrement request for the post cursor tap coefficient of the TX filter to compensate for channel distortions;
forwarding each increment request and each decrement request to a remote receiver by a local transmitter through a back communication channel;
detecting either over equalization or under equalization at the local receiver; and
if over equalization is detected, generating a request for a reduction of absolute value for the post cursor tap coefficient of the TX filter, and
otherwise, if under equalization is detected, generating a request for an increase of absolute value for the post cursor tap coefficient of the TX filter.

2. The method of claim 1, wherein, for the enhancing and applying equalization to the received serial signal:
performing enhancement of the serial signal by i) applying a gain or an attenuation with a variable gain amplifier (VGA) and ii) frequency filtering and equalizing with a receiver front end equalizer (RXFE) to generate enhanced data;
sampling and deserializing the enhanced signal with a slicers circuit and a deserializer, respectively;
applying equalization to the deserialized signal with a decision feedback equalizer (DFE) to generate feedback data;
combining the enhanced data with DFE feedback data for sampling; and
adaptively adjusting coefficient values of the DFE.

3. The method of claim 1, wherein the detecting over equalization or under equalization includes comparing signal transition timing to long run transition timing within a data eye.

4. The method of claim 3, wherein the detecting over equalization or under equalization is by evaluating at least one data transition sequence.

5. The method of claim 4, wherein, for the detecting over equalization, the at least one data transition sequence includes x110 and x001.

6. The method of claim 1, wherein the step of determining each request is based on determining group delay gradients for the received serial signal to either side from a locked transition of clock and data recovery timing.

7. The method of claim 6, wherein the step of determining each request employs using a table of absolute-valued post cursor values.

8. The method of claim 1, wherein the over equalization is by building up the post cursor tap coefficients of the TX filter to a higher than optimal value due to signal compression and adaption loop interaction.

9. The method of claim 1, wherein the method for group delay-based post cursor adaptation comprises decoupling of i) applying DFE equalization, the DFE equalization based on least mean square (LMS) adaptation of coefficients of the DFE, and equalization to the received serial signal by a linear equalizer (LEQ) from ii) applying transmit filtering to the serial signal based on group delay adaptation of coefficients of the TX filter.

10. The method of claim 9, wherein the equalization to the received serial signal by the LEQ includes either LMS-based adaptation or group delay-based adaptation of coefficients of the LEQ.

11. Apparatus for group delay-based post cursor adaptation in a communication system, comprising:
a local receiver configured to receive a serial signal from a communication channel from a remote transmitter, wherein at least a portion of interference introduced into the serial signal passing through the communication channel is compensated for by applying a transmit (TX) filter in the remote transmitter to the serial signal, wherein the TX filter includes at least one pre- and post-cursor tap with corresponding pre- and post-cursor tap coefficients, respectively;
an amplifier and receiver front end equalizer (RXFE) configured to enhance and apply equalization to the received serial signal;
a controller configured to determining either a hold, an increment request, or a decrement request for the post cursor tap coefficient of the TX filter to compensate for channel distortions; and
a local transmitter configured to forward each increment request and each decrement request to a remote receiver by a local transmitter through a back communication channel;
wherein the controller is configured to detect either over equalization or under equalization at the local receiver; and
if over equalization is detected, generate a request for a reduction of absolute value for the post cursor tap coefficient of the TX filter, and
otherwise, if under equalization is detected, generate a request for an increase of absolute value for the post cursor tap coefficient of the TX filter.

12. The apparatus of claim 1 wherein, when the an amplifier and RXFE enhances and applies equalization to the received serial signal:
performing enhancement of the serial signal by i) applying a gain or an attenuation with a variable gain amplifier (VGA) and ii) frequency filtering and equalizing with the RXFE to generate enhanced data;
sampling and deserializing the enhanced data with a slicers circuit and a deserializer, respectively, to generate a deserialized signal;
applying equalization to the deserialized signal with a decision feedback equalizer (DFE) to generate feedback data;
combining the enhanced data with DFE feedback data for sampling; and
adaptively adjusting coefficient values of the DFE.

13. The apparatus of claim 11, wherein the controller detects the over equalization or the under equalization by comparing signal transition timing to long run transition timing within a data eye.

14. The apparatus of claim 13, wherein the controller detects the over equalization or the under equalization by evaluating at least one data transition sequence.

15. The apparatus of claim 14, wherein, when the controller detects over equalization, the at least one data transition sequence includes x110 and x001.

16. The apparatus of claim 11, wherein the controller determines each request based on determining group delay gradients for the received serial signal to either side from a locked transition of clock and data recovery timing.

17. The apparatus of claim 16, wherein the controller determines each request using a table of absolute-valued post cursor values.

18. The apparatus of claim 11, wherein the over equalization is building up of the post cursor tap coefficients of the TX filter to a higher than optimal value due to signal compression and adaption loop interaction.

19. The apparatus of claim 11, wherein:
the apparatus for group delay-based post cursor adaptation is configured to decouple i) applying DFE equalization, the DFE equalization based on least mean square (LMS) adaptation of coefficients of the DFE, and equalization to the received serial signal by a linear equalizer (LEQ) from ii) applying transmit filtering to the serial signal based on group delay adaptation of coefficients of the TX filter, and
the equalization to the received serial signal by the LEQ includes either LMS-based adaptation or group delay-based adaptation of coefficients of the LEQ.

20. A non-transitory machine-readable medium, having encoded thereon program code, wherein, when the program code is executed by a machine, the machine implements a method for group delay based post cursor adaptation in a communication system, the method comprising the steps of:
receiving, at a local receiver, a serial signal from a communication channel from a remote transmitter, wherein at least a portion of interference introduced into the serial signal passing through the communication channel is compensated for by applying a transmit (TX) filter in the remote transmitter to the serial signal, wherein the TX filter includes at least one pre- and post-cursor tap with corresponding pre- and post-cursor tap coefficients, respectively;
enhancing and applying equalization to the received serial signal;
determining either a hold, an increment request, or a decrement request for the post cursor tap coefficient of the TX filter to compensate for channel distortions,
forwarding each increment request and each decrement request to a remote receiver by a local transmitter through a back communication channel;
detecting either over equalization or under equalization at the local receiver; and
if over equalization is detected, generating a request for a reduction of absolute value for the post cursor tap coefficient of the TX filter, and
otherwise, if under equalization is detected, generating a request for an increase of absolute value for the post cursor tap coefficient of the TX filter.
